(19) United States
(12) Patent Application Publication
(10) Pub. No.: US 2002/0080267 A1
(43) Pub. Date: Jun. 27, 2002

(54) High capacity, low-latency multiplexer

(76) Inventor: Allan Moluf, San Jose, CA (US)

Correspondence Address: BROMBERG & SUNSTEIN LLP, 125 SUMMER STREET, BOSTON, MA, 02110-1618, US

(21) Appl. No.: 09/996,102

(22) Filed: Nov. 28, 2001

Related U.S. Application Data
(60) Provisional application No. 60/253,526, filed on Nov. 28, 2000.

(51) Int. Cl. H04N 7/12; H04N 11/02

(52) U.S. Cl. 348/385.1

(57) ABSTRACT

A method for multiplexing compressed video data streams where the time for sending portions of a video frame are adjusted to reduce latency. If a compressed frame cannot be delivered in the appropriate frame time, due to bandwidth limitations, the frame is broken into parts and a part is sent in an earlier frame time. This method allows complete frames to be available at a receiver at the correct time. Accurate methods of deriving clock signals from the data stream are also described.

This application claims priority from provisional U.S. Patent Application, No. 60/253,526, filed Nov. 28, 2000, entitled “High Capacity, Low-Latency Multiplexer,” attorney docket number 1436/143, which is incorporated by reference herein in its entirety.

### TECHNICAL FIELD AND BACKGROUND ART

This invention relates to multiplexers for combining streams of compressed digital data.

One function of MPEG systems is to provide a means of combining or multiplexing several types of multimedia information into one transport stream that can be transmitted on a single communication channel or stored in one file of a digital storage medium. Since MPEG data are always byte aligned, the bit streams are actually byte streams, and will hereinafter be referred to as streams. Multiplexing in MPEG systems is achieved by packet multiplexing. Elementary streams consist of compressed data from a single source (e.g. audio video, data, etc.) plus ancillary data needed for synchronization, identification and characterization of the source information. With packet multiplexing, fixed length data packets from the several elementary streams of audio, video, data etc. are interleaved one after the other into a single MPEG stream as shown in FIG. 1. Elementary streams and MPEG streams can be sent either at constant bitrate or variable bitrates simply by varying the frequency of the packets appropriately. Multiple sources of data may be multiplexed together into a single MPEG transport stream. For example, multiple MPEG encoded video games or multiple MPEG encoded movies may be sent in a single MPEG transport stream in a channel.

Networked systems, including cable television systems, which desire to provide an interactive experience with end users using MPEG (or another similarly compressed data stream containing varying frame sizes) must reduce latency caused by the system to maintain the perception by the end user of instantaneous feedback. Latency can result due to the round trip travel time in the network itself, or in systems which use MPEG encoding to transmit digital information, latency can also be attributed to the compression mechanism. The latency arises because compression schemes such as MPEG require one or more frame delays in the encoding process plus additional frame delays in the decoder due to the varying sizes of video frames and the interrelationship between I, P, and B frames. For example, I frames are, in general, 5 to 10 times larger than P or B frames and decoding B frames requires the following reference frame to have already been decoded. Ideally, an I frame of video should be sent to the decoder during a frame time (which for NTSC systems is 1/30th second), however due to the desire to maintain a maximum number of elementary streams in the MPEG stream for a given bandwidth, statistically a complete I frame should not be sent during a frame time due to the risk of encountering collisions with other I-frames being simultaneously transported. If complete I frames are sent into a channel simultaneously, the bandwidth of the channel may be exceeded. In order to achieve the maximum number of simultaneous transmissions of MPEG encoded elementary streams and avoid collisions, traditional systems have sent the I-frames over a period of 5-10 frame times. As a result, latency is increased in such a system because the I-frame cannot be displayed until it has been completely received and decoded. This forces all frames to be delayed enough to handle the largest I-frame. As the latency increases beyond 100 ms (or the equivalent of 3 NTSC frame times), the feeling of responsiveness decreases sharply.

### SUMMARY OF THE INVENTION

One embodiment of the present invention is directed to an interactive cable system in which multiple MPEG video streams are sent into a fixed bandwidth channel. The video streams contain at least I frames and P frames of video data and may also include B frames. In order to take advantage of the bandwidth of the channel and send multiple video streams, the video frames are usually transmitted during a frame time which is equivalent to the duration of time that a frame of video is displayed on a display device. Each frame is divided into packets of a fixed size for transmission. In such a configuration, to reduce latency, a portion of the packets constituting an I frame may be sent during an earlier frame time along with the packets of the previous P or B frame. By doing so, the statistical chances of collision between complete I frames being sent simultaneously into the channel which could exceed the bandwidth of the channel is reduced through peak flattening of the overall video stream transmission rate. Thus, the packets comprising an I frame are distributed over a longer time interval without incurring additional latency. In this embodiment when collisions do occur, the packets of a video frame which were not sent during the scheduled frame time are given priority over other video frame packets which are scheduled to be sent at a specified time.

In another embodiment of the present invention, a method is provided for synchronizing a local clock with a data stream. The method includes repeatedly reading a local clock, determining a reference time from the data stream and calculating an error value until a predetermined number of error values have been calculated; grouping error values into a plurality of groups and performing a linear regression on the minimum error value in each group to determine a clock drift error value; and correcting the local clock using the clock drift error value and current drift rate.

### BRIEF DESCRIPTION OF THE DRAWINGS

FIG. 1 is an exemplary multiplexer of compressed video streams.

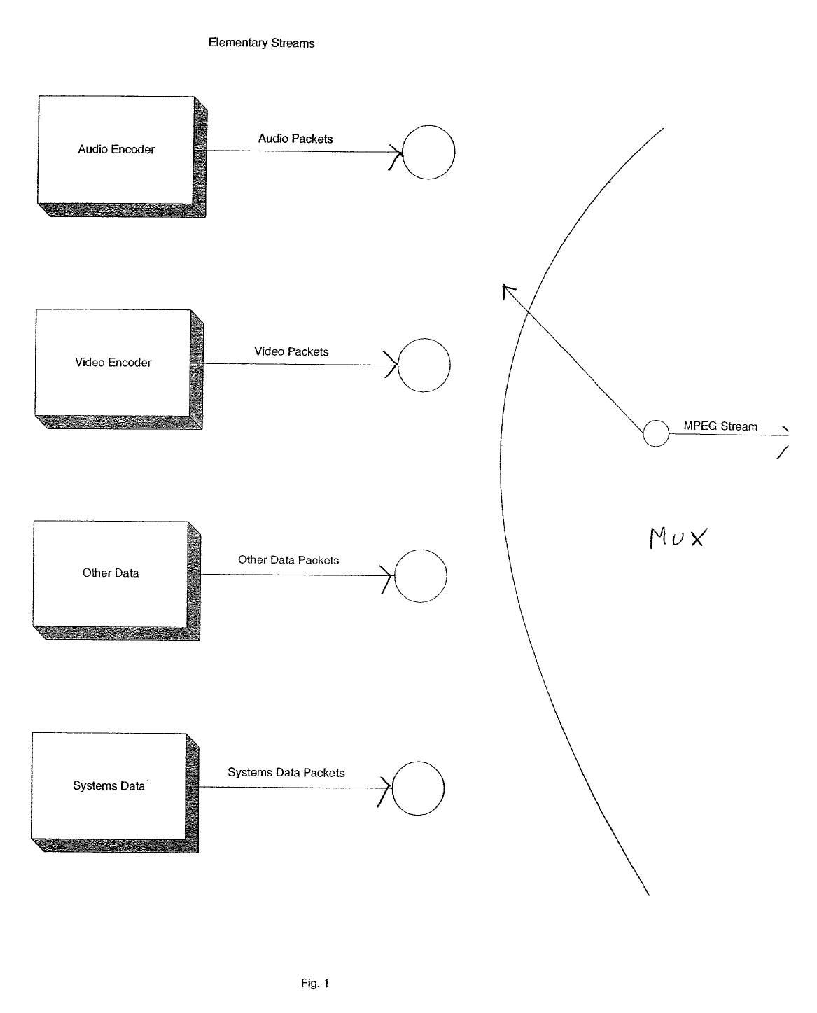

FIG. 2 is a block diagram of a head end for an embodiment of the present invention.

FIG. 3 is a block diagram of a back end for use in a head end of FIG. 2.

FIG. 4 is a block diagram of a front end use in the head end of FIG. 2 with an exploded view of a digital user service module.

FIG. 5 is a block diagram showing one embodiment of the present invention.

FIG. 6 illustrates combining input data streams into a multiplexed output data stream.

FIG. 7 is a graphical representation of an embodiment of the present invention in which an I packet is segmented and divided into frames N and N-1.

FIG. 8 is a flow chart showing a method for adjusting for clock drift.

### DETAILED DESCRIPTION OF SPECIFIC EMBODIMENTS

For the purposes of the description herein and any appended claims, unless the context otherwise requires, the terms “cable television environment” and “cable television system” include all integrated systems for delivery of any information service to subscribers for use in connection with their televisions. These include conventional cable television systems utilizing coaxial cable for distribution primarily of broadcast and paid television programming, cable television systems using fiber optics and mixed fiber optic-coaxial cable, as well as other means for distribution of information services to subscribers.

Similarly, unless the context otherwise requires, the term “information service” includes any service capable of being furnished to a television viewer having an interface permitting (but not necessarily requiring) interaction with a facility of the cable provider, including but not limited to an interactive information service, video on demand, Internet access, local origination service, community event service, regular broadcast service, etc. “Television communication” means providing an information service via a television information signal. A “television information signal” is any signal that may be utilized by a television for video display, regardless of the form, including a standard NTSC-modulated RF carrier, an MPEG-compressed digital data stream, or any other format. “Interactive television service” means an information service that utilizes an interface affording two-way communication with a facility of the cable provider. “Interactive pages” are defined herein to include still video frame images or a multimedia short script for interpretation by a local process such as a typical page of HTML data as practiced by conventional web browsers. Thus the interactive page may show cursor movement or flashing or revolving images under local process control. An interactive page is typically sent intermittently from the frame server. It does not require the frame server to continually send video information multiple times a second.

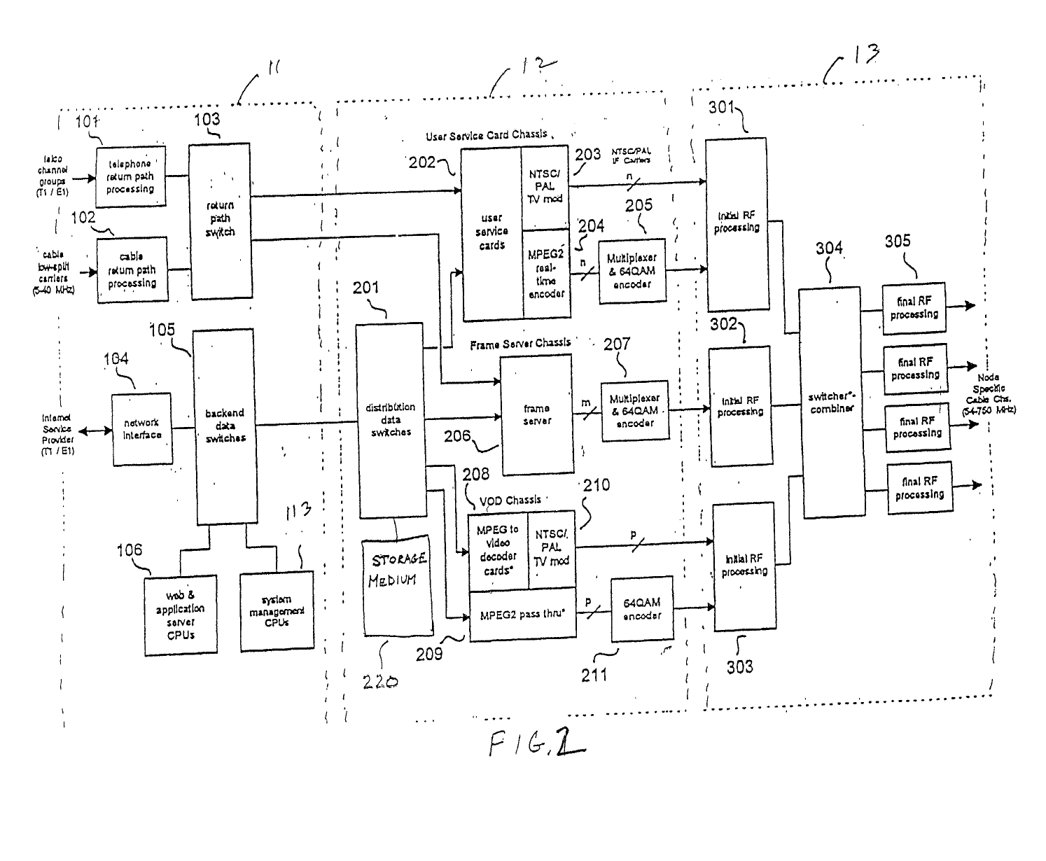

A cable television system comprises a head end and a distribution plant. The cable distribution plant includes a cable distribution network having bridger amplifiers, feeders, feeder amplifiers, and cable drops serving homes or other destinations. FIG. 2 is an exemplary embodiment for implementing a device and method for a high capacity, low latency multiplexer.

Referring now to FIG. 2, a head end is illustrated for providing interactive services. The head end includes back end 11, front end 12, and switching output RF hub 13. Data communication from subscribers is delivered through a return data path to the back end 11 of the head end. One alternative return path is through telephone lines to telephone return path processing block 101. Another alternative return path is through a reserved frequency band throughout the cable network. For example, the 5-40 MHz band may be reserved for data communication from subscribers to the head end. Cable return path processing block 102 is in communication with such signals provided over a cable return path. Telephone return path processing 101 and cable return path processing 102 are connected through return path switches 103 with user service cards 202 and frame server 206. The user service cards 202 each contain a processor that acts as an interactive controller which is individually assignable to a requesting subscriber on a demand basis. The interactive controller receives the data from its assigned subscriber and produces the information to be delivered to the subscriber in a television signal. The frame server 206 is a processor which runs individually assignable interactive control processes. Each interactive process on the frame server 206 responds to data from its assigned subscriber and produces the information to be delivered to the subscriber in the form of a television signal.

The back end 11 further provides information sources to the front end 12. A network interface 104 is in communication with an Internet service provider. Back end switches 105 are in communication with the network interface 104 and web and application server CPU's 106 as well as system management CPUs 113. Communications are completed with the front end 12 through back end switches 105 via distribution switches 201. Because the user service cards in a preferred embodiment are diskless and lack ROM with stored software necessary for bootup, server 106 may also provide the means for the interactive controllers to boot-up. Also, server 106 provides a web proxy server function so that information downloaded from a remote server on the Internet is quickly cached on server 106.

Distribution switches 201 provide communication signals and control signals to the user service cards 202, the frame server 206, MPEG to video decoder cards 208 and MPEG-2 pass through 209. MPEG and MPEG-2 digital encoding schemes are referred to herein for purposes of illustration only. Those skilled in the art will readily recognize that embodiments of the present invention may be applied to other currently available and later developed schemes for encoding video information with digital signals. Further, the technique described herein and its implementation may be used with any system in which a compression scheme produces varying sized data representations for a fixed time period. The user service cards may be dedicated to any of a variety of interactive services. For example, there may be Internet service cards for running web browser processes and other video game player cards for running video game processes. The MPEG-to-video decoder cards 208 and the MPEG-2 pass through 209 are for providing video to subscribers on demand and for providing access to Web pages.

NTSC/PAL TV modulator cards 203 provide analog television signals from the outputs of the user service cards 202. The television signals are in the form of NTSC or PAL IF (intermediate frequency) signals. NTSC/PAL TV modulator cards 210 are also provided for providing video on demand on analog signals. The analog signals from the user card chassis NTSC/PAL TV modulators 203 and the video on demand NTSC/PAL TV modulators 210 are provided to initial RF processing 301 and 303, respectively, in the switching output RF hub 13. The initial RF processing includes up-converting the NTSC/PAL IF carrier signals onto a frequency determined by the channel frequency assigned to the subscriber destination. Channel assignment and control of any adjustable up-converters is handled by system management CPUs 113 which are in communication with the switching output RF hub 13 through communication lines not shown. In an embodiment of the invention, a user service card 202, an NTSC/PAL modulator 203 and an up-converter may all be packaged in a single module. The module as a whole would be assigned to a requesting subscriber.

MPEG-2 real time encoders 204 provide digital television signals from the outputs of the user service cards 202. The frame server 206 includes an MPEG encoder to provide digital television signals as well. Videos may be stored in MPEG format and may therefor use pass through 209 to directly provide digital television signals. The digital signals are combined into a composite QAM (quadrature amplitude modulation) signal before going to initial RF processing. The digital signals are multiplexed so that many different signals may be carried on a single analog carrier. Multiplexer and QAM encoder 205 receives signals from the user chassis' MPEG-2 real time encoders 204. Multiplexer and QAM encoder 207 receives signals from the frame server 206. QAM encoder 211 handles the video signals from the video on demand chassis. Within switching output RF hub 13, initial RF processing 301, 302, 303 is performed in which there is one RF module per simultaneous user. The output of RF processing 301, 302, 303 is switched for delivery to the service area of each respective subscriber destination and all signals going to a particular service area are combined via switcher-combiner 304. The combined signals for each service area pass through a final RF processing 305.

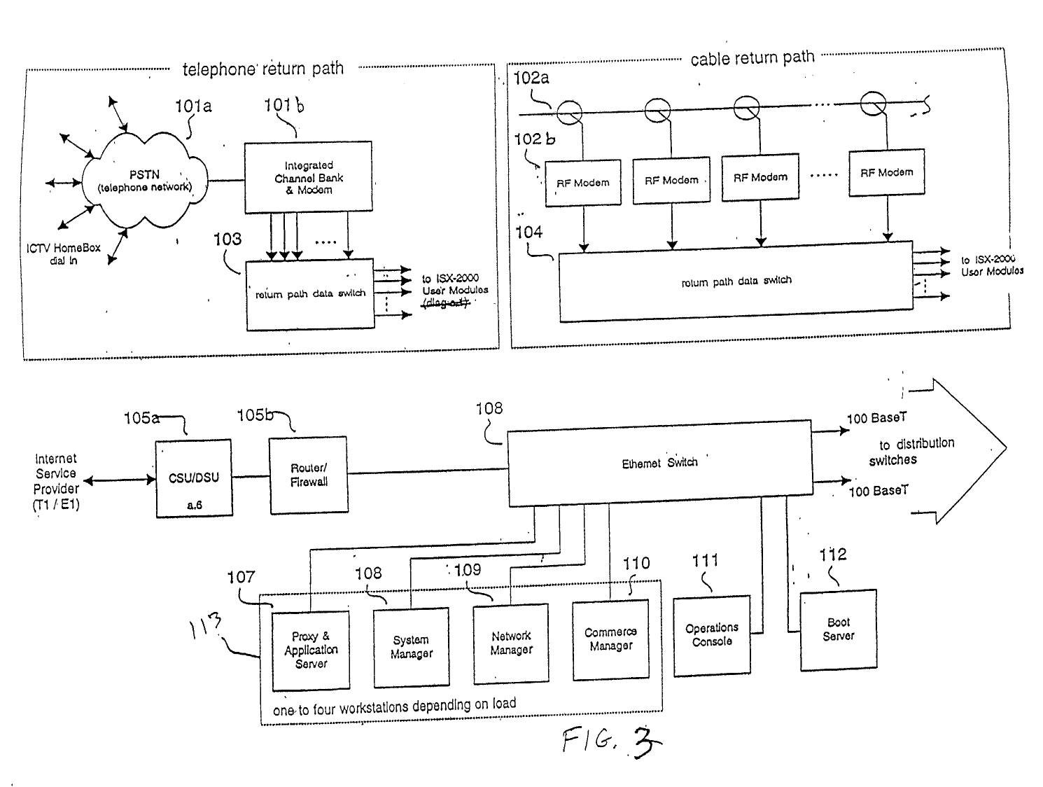

An embodiment of back end 11 is shown in more detail in FIG. 3. Cable return path processing 102 is provided by a bank of RF modems 102b. Splitters 102a extract cable signals for processing by the RF modems 102b. Telephone return path processing 101 is provided through the public service telephone network 101a to an integrated channel bank and modem 101b. Network interface 104 is provided by router firewall 105b and CSU/DSU (customer service unit/data service unit) 105a. Router firewall 105b is in communication with Ethernet switch 108. Also shown in FIG. 3 are web proxy and application server 107, system manager 108, network manager 109 and commerce manager 110 in communication with Ethernet switch 108. System manager 108 provides for the allocation of resources to permit interactive services with a user, as well as procedures for call set-up and tear down. Commerce manager 110 manages real-time transactions and converts billing to a batch format for handling by legacy systems. Also shown in FIG. 3 are operations console 111 and boot server 112 in communication with Ethernet switch 108.

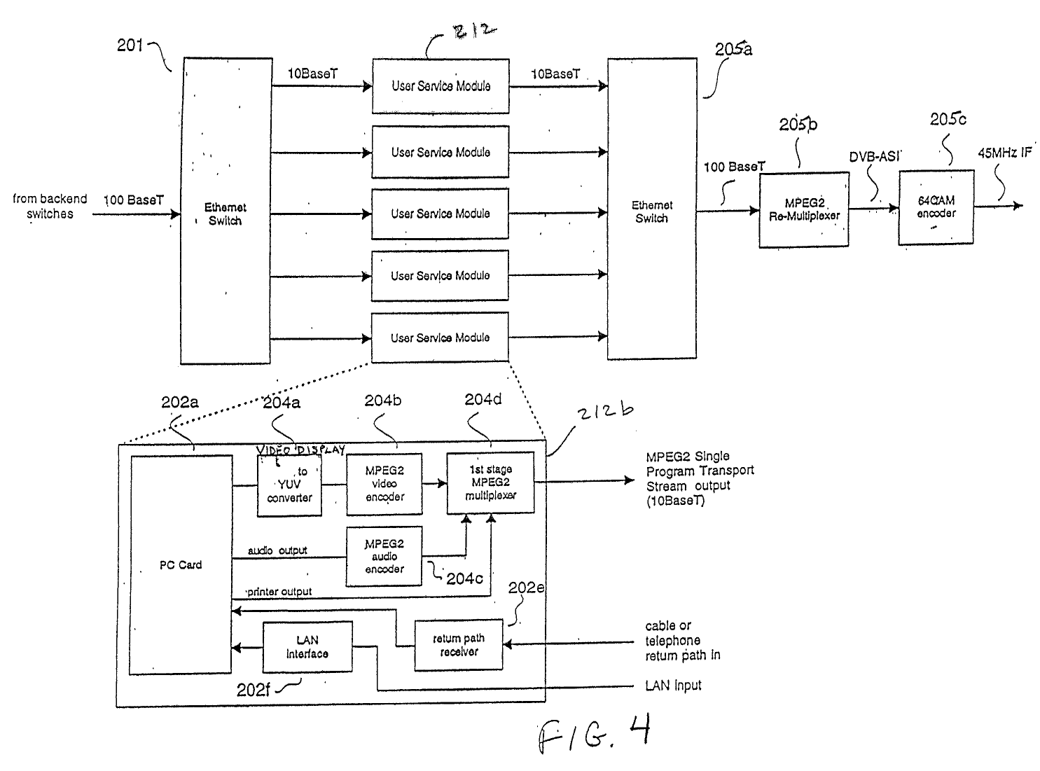

An embodiment of front end 12 is shown in FIGS. 4. The user service cards are preferably each housed in a single user service module 212. Ethernet switches 201 are connected to the user service modules 212.

FIG. 4 illustrates a digital user service control module 212b. In the digital control module 212b, the information signal from the PC card 202a is provided to a VGA to YUV converter 204a. The digital YUV output is encoded. The presently preferred encoder is an MPEG-2 video encoder 204b and an associated MPEG-2 audio encoder 204c. The encoded digital television signal is input to a first stage of an MPEG-2 multiplexer 204d. To the extent the cable system is also used to handle print requests from subscribers, printer output can be sent from the PC card 202a to the first stage of the MPEG-2 multiplexer. The printer output would ultimately be directed through the cable system to a settop and a printer connected to the settop.

All outputs from the first stage MPEG-2 multiplexers 204d are passed to the multiplexer and QAM encoder 205. This includes Ethernet Switch 205a, MPEG-2 Re-Multiplexer 205b and QAM encoder 205c. The QAM encoder 205c produces a 44 MHz IF signal which can then be upconverted in initial RF processing 301.

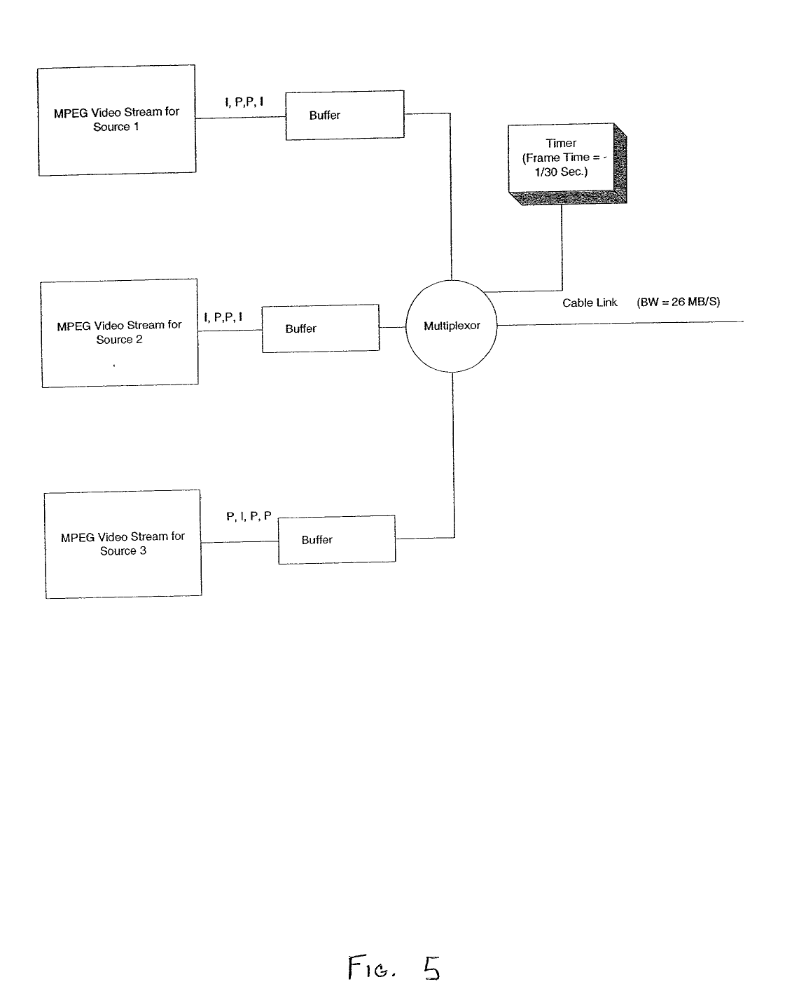

FIG. 5 shows an embodiment of the present invention in which multiple MPEG video data streams are each first placed into a buffer and then formed into a single data stream by a multiplexer for distribution by a cable network to end users. The multiplexer and buffer are equivalent to 204d of FIG. 4. Each MPEG video data stream is composed of compressed frames of video (i.e., I Type, P Type or B Type). Each compressed frame of video has an associated size, wherein I type frames are typically 5 to 10 times larger than a P or B frame. Given that the cable distribution network has an associated bandwidth which typically is on the order of 27 Mb/s (certain cable systems use 26.97 Mb/s and others 38.81 Mb/s), maximizing the bandwidth becomes an issue of importance as the MPEG video streams are multiplexed onto the cable distribution network. In an ideal situation each frame of a video stream would be sent during a single frame time wherein a frame time corresponds to the length of time that the frame of video will be displayed on a display device (e.g., for NTSC systems, 1/30 of a second). Since I frames are substantially larger than P or B frames and given that multiple streams having different originating sources may each produce I frames during one frame time, the system must be designed so that such a transmission of I frames will not exceed the bandwidth of the channel (the cable distribution network). For example, in a system in which, an I frame occurs approximately once for 30 video frames, assuming that a multiplexer is capable of transmitting about 600 packets of data during one frame time and wherein there are 20 different streams, there is a significant statistical likelihood that 4 I frames will be simultaneously transmitted during a frame time. If each I frame of video data is 200 packets, the multiplexer will attempt to transmit 800 packets during a frame time when the channel's capacity is only 600 packets. A method must be employed to deal with such a load. Prior art methods of dealing with such an overload frequently add latency to transmission of all the packets associated with a frame in an incoming data stream.

An exemplary scheduler and buffer according to an embodiment of the invention are used within the multiplexer to avoid collisions and to reduce latency. Rather than sending I frame packets over several subsequent frame times as is traditionally done, the scheduler reschedules the time for sending packets from an I frame which are resident in the buffer to a previous frame time as compared to the scheduled frame transmission time for the I frame packets. Given that the packets for each video frame have a scheduled time for being placed into the channel, a number of I frame packets are rescheduled such that the packets would be sent at least one frame time preceding the scheduled time. The number of packets that are rescheduled may be predetermined or set adaptively. The remaining packets of the I frame are transmitted during the scheduled frame transmission time. It will be understood by those skilled in the art that P or B frame packets do not occupy all of the bandwidth for a given frame time due to compression where the maximum data contained within a frame time is defined as being equivalent to the size of an I frame. By rescheduling the packets of a frame which is being buffered prior to the scheduled time for transmission of the packets, the maximum number of packets transmitted during any one frame time is redistributed.

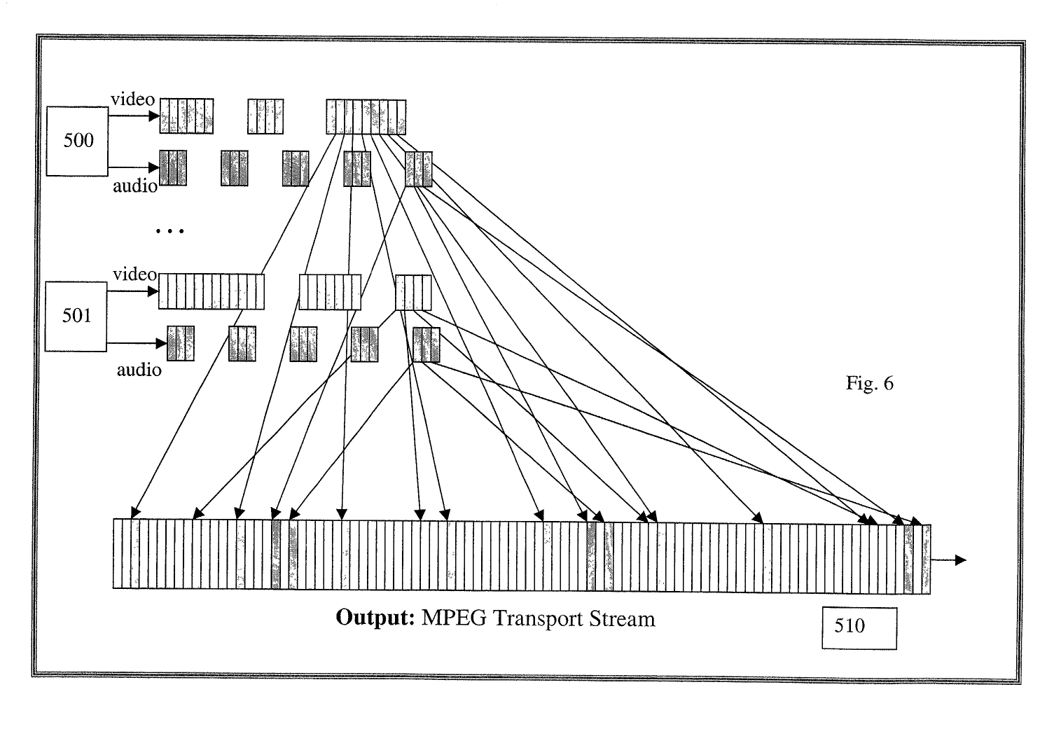

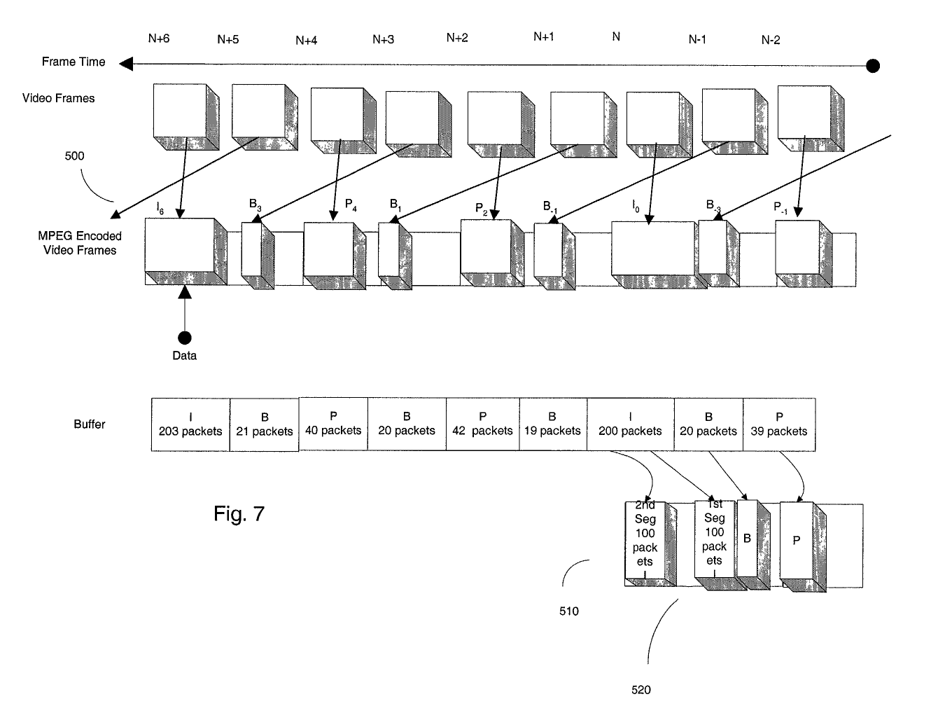

For example, FIG. 6 illustrates the multiplexing of input video data streams 500 and 501 into an output MPEG transport stream 510. With respect to FIG. 7, 100 of the 200 packets of a typical I-frame which would normally be sent during frame time N will be transmitted in the output data stream 510 during frame time N-1 in conjunction with packets of the previous P or B frame 520. The system is configured such that as packets of MPEG video frames enter the buffer, the packets are identified as coming from I, B, or P frames. When packets from an I frame are encountered, a number of packets have their transmission time (frame time) rescheduled by a scheduler, such that the rescheduled packets are transmitted during an earlier frame time. The number of packets which are rescheduled are limited such that the total number of packets to be transmitted during an earlier frame time including the regularly scheduled packets for that frame time do not exceed the size of a comparable I frame. The ability of the system to capture the previous frame time prior to transmission is due to a created latency such that there is at least one frame time delay in the buffer prior to transmission. By performing such an operation, the peak data rate is reduced and statistically more MPEG video streams may be transmitted with the same bandwidth. Further, the chance of simultaneously transmitting data during the same frame time which is in excess of the bandwidth of the cable link is greatly reduced. When collisions do occur, such that packets are not transmitted, these packets are rescheduled with the next earliest frame time and are given priority over all other packets.

On the decoder side, each packet is placed into a buffer and I frames are reconstructed, as needed. Since the entire I frame completely arrives during the scheduled time frame time, no latency is added to the system. It should be understood by one skilled in the art that one or more elementary audio streams composed of audio frames may be included into the MPEG stream. It should also be understood that audio streams have a fixed frame size and thus are not subject to the same problems as the variably sized video frames. Further, the technique described herein, is equally applicable to any system in which variably sized frames of data are required to be received during a set time interval.

In another embodiment of the invention, the multiplexer needs to generate an accurate presentation time stamp for the packets of the elementary streams which are being released into the channel. For accurate MPEG reproduction of a broadcast color sub-carrier on a television set the clock providing the time stamp must be accurate to 3 parts in a million for the Program Clock Reference (“PCR”) from which the System Time Clock (“STC”) is derived. It should be understood by those of ordinary skill in the art that an MPEG transport card having a stable and accurate timing crystal which is used for releasing the MPEG stream into the channel potentially could be used to derive the STC. However, the clocking crystal can only be indirectly referred to and thus there is an unavoidable error in the range of milliseconds which does not provide the needed accuracy for proper color reproduction.

In order to determine an STC, a high precision local clock (typically sub-microsecond), such as a personal computer's (“PC”) internal clock, is used to determine the current time value for the system time clock. However, the clock on a PC drifts relative to a stable clock, so it is necessary to compare the time value of the local clock to an accurate time value.

Since errors in reading the CPU clock of a PC (occasionally as large as several msec.) are always delays and therefore additive, the error distribution for the local clock is unimodal. Using the minimum error of a number of adjacent samples rather than the actual errors which contain unpredictable delays, the error is reduced for the regression significantly (on the scale of 2-4 orders of magnitude in practice). Then a linear regression using the minimum values will obtain a greatly reduced standard error compared to a regression using all of the data samples. By using the minimum error the number of necessary sample points is reduced (by 3-7 orders of magnitude). Equivalently, the number of samples and thus the time required to achieve a sufficiently small standard error can be reduced (by 3-7 orders of magnitude).

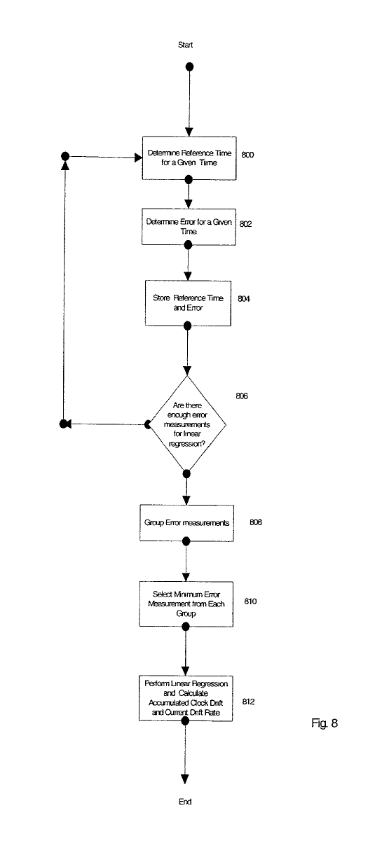

The method is performed as shown in the flow chart of FIG. 8. A reference time is determined based upon the system time clock plus the number of samples received times the known length of each sample. (Step 800) A difference or error is calculated by determining the current system time (time as measured by the PC clock) and comparing it to the reference time (Step 802). A limited set of error values is maintained. (Step 804). Conceptually the system continues to store error values until there are a sufficient number stored, typically in the range of 100-100,000 values. (Step 806) The error values are then grouped together in small sets, of approximately 5 to 10 values, for each group (Step 808). The minimum values from each group are then accessed (Step 810) and used to compute a best-fit line to estimate the accumulated drift and current drift rate (Step 812). These steps may be continually repeated in order to remain locked onto the external clock. In a specific embodiment of the invention, to limit the memory required for the samples and to distribute the computation time over a large interval, only the minimum error of the current set and a number of sums are kept during the sample acquisition. The most recent regression results may be used to determine the error for a given time and eliminate the drift error.

It should be noted that the flow diagram is used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Oftentimes, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies, networking technologies, and internetworking technologies. The computer program may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.)

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL.)

The present invention may be embodied in other specific forms without departing from the true scope of the invention. The described embodiments are to be considered in all respects only as illustrative and not restrictive.

What is claimed is:

1. A method for multiplexing compressed video input data streams, each input data stream divided into video frames, into an output data stream with low latency, the method comprising:
a. receiving each input data stream;
b. providing an input buffer, the buffer capable of holding at least a maximum-size video frame for each input data stream; and
c. when a given video frame in a given input data stream is larger than a threshold size, dividing the given video frame into at least a first part and a second part and rescheduling at least one part of the given video frame for transmission in the output data stream earlier than the corresponding frame time in the output data stream.

2. A method according to claim 1, wherein the threshold size is predetermined.

3. A method according to claim 1, wherein the threshold size is determined adaptively.

4. A method according to claim 1 wherein at least one of the input data streams is an MPEG-encoded video stream.

5. A multiplexer for combining a plurality of compressed video input data streams into an output data stream, each input data stream divided into video frames, the multiplexer comprising:
a. logic for scheduling the transmission of video frames in the output data stream; and
b. logic for dividing a given video frame in a given input data stream into at least a first part and a second part and rescheduling at least one part of the given video frame for transmission in the output data stream earlier than a corresponding frame time for the given video frame, when the given video frame is larger than a threshold size.

6. A multiplexer according to claim 5, wherein the threshold size is predetermined.

7. A multiplexer according to claim 5, wherein the threshold size is determined adaptively.

8. A multiplexer according to claim 5, wherein at least one of the input data streams is an MPEG-encoded video stream.

9. A method for synthesizing a stable clock from a local clock and a data stream, the local clock subject to drift errors, comprising:
a. reading a local clock time from the local clock, determining a reference time from the data stream and calculating an error value between the reference time and the local clock time until a predetermined number of error values have been calculated;
b. grouping the error values into a plurality of groups and performing a linear regression on the minimum error value in each group and determining a clock drift error value and current drift rate; and
c. synthesizing the stable clock including correcting the local clock using the clock drift error value and current drift rate.

10. A method according to claim 9 wherein the data stream includes multiplexed video streams.

11. A method according to claim 9 wherein the data stream is an MPEG-encoded video stream.

12. A device for synthesizing a stable clock from a local clock and a data stream, the local clock subject to drift errors, comprising:
a. logic for reading a local clock time from the local clock, determining a reference time from the data stream and calculating an error value between the reference time and the local clock time until a predetermined number of error values have been calculated;
b. logic for grouping error values into a plurality of groups and performing a linear regression on the minimum error value in each group and determining a clock drift error value and current drift rate; and
c. logic for synthesizing the stable clock by correcting the local clock using the clock drift error value and current drift rate.
